(19) United States
(12) Patent Application Publication
(10) Pub. No.: US 2010/0003592 A1
(43) Pub. Date: Jan. 7, 2010

(54) ALL SOLID STATE SECONDARY BATTERY

(75) Inventors: Mamoru Baba, Iwate (JP); Shoichi Iwaya, Niigata (JP); Hitoshi Sumura, Niigata (JP); Hiroshi Sato, Niigata (JP); Hiroshi Sasagawa, Niigata (JP); Noriyuki Sakai, Niigata (JP); Takayuki Fujita, Niigata (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: INCORPORATED NATIONAL UNIVERSITY IWATE UNIVERSITY, IWATE (JP)

(21) Appl. No.: 12/449,532

(22) PCT Filed: Feb. 13, 2007
(86) PCT No.: PCT/JP2007/052531

§ 371 Date: Aug. 20, 2009

(51) Int. Cl. H01M 6/42

(52) U.S. Cl. 429/149; 29/623.5; 29/623.3

(57) ABSTRACT

This is to provide an all solid state secondary battery which can be produced by an industrially employable method capable of mass-production and has excellent secondary battery characteristics.

This is an all solid state secondary battery comprising a laminated material,
wherein the laminated material comprises a plurality of cell units and optionally a collector layer(s) constituting one of or both of an uppermost layer and a lowermost layer of the laminated material, wherein each of the cell units comprises a positive active material layer, an ion-conductive inorganic-material layer and a negative active material layer which are continuously arranged in this order, and is laminated so that the positive active material layer and the negative active material layer of adjacent cell units face each other, wherein (a) the laminated material is a product of co-firing, (b) each of the layer is in a sintered state, or (c) at least the ion-conductive inorganic-material layer is formed from a calcined powder of the ion-conductive inorganic-material.

### TECHNICAL FIELD

The present invention relates to an all solid state secondary battery comprising a series type laminated material which is a product of co-firing.

### BACKGROUND ART

Heretofore, as a secondary battery, optimization of a positive active material, a negative active material and an organic solvent electrolyte, etc., to be used has been carried out mainly in a non-aqueous electrolyte secondary battery (lithium ion secondary battery) using an organic solvent. A produced amount of the non-aqueous electrolyte secondary battery is markedly increasing accompanying with remarkable development of digital home appliances using the battery.

However, in the non-aqueous electrolyte secondary battery, there is pointed out in danger of catching fire since it uses inflammable organic solvent electrolyte, and the organic solvent electrolyte to be used decomposes by a reaction in the electrode to expand an outer can of the battery, and occasionally it causes leakage of the electrolyte.

Thus, an all solid state secondary battery which uses a solid electrolyte in place of the organic solvent electrolyte has attracted attention. The all solid state secondary battery does not structurally require a separator, and there is no fear of leakage of the electrolyte so that no outer can is required.

Regarding properties, the all solid state secondary battery does not use any organic solvent electrolyte, a battery having no danger of catching fire can be constituted, and the solid electrolyte has ion selectivity, so that there is less side reaction and efficiency of the battery can be heightened, and as a result, a battery excellent in charge-discharge cycle properties can be expected.

For example, in Patent Literature 1, there is disclosed a wholly solid type substrate-mounted type secondary battery having a thin-film shaped electrode and a solid electrolyte without using any lithium metal piece. In this secondary battery, a small-sized and light-weighted lithium secondary battery is intended to be prepared by forming an electrode and an electrolyte with a sputtering method, electron beam deposition method, heat deposition method, etc., whereby the constituted product is made as thin as possible.

In Patent Literature 2, there is disclosed a laminated type thin-film solid lithium ion secondary battery in which a thin-film solid secondary battery cell comprising a positive active material, a solid electrolyte and a negative active material formed by a sputtering method is laminated two or more layers. This laminated type thin-film solid lithium ion secondary battery is laminating elements so as to connect them by a series or a parallel, so that it has been said to have effects that it can be applied to a high power appliance such as electric vehicles as a high-voltage or a high-current electric source, etc. However, thin-film wholly solid lithium ion secondary batteries disclosed in these prior art references are each produced by a sputtering method, etc., so that a film-formation rate of a thin-film of an electrode or a solid electrolyte is extremely slow. For example, for producing a battery constituted by a positive active material, a solid electrolyte and a negative active material with a thickness of 1.0 μm on a substrate, the film-formation time is 10 hours or longer. It is extremely difficult to employ such a method with a slow film-formation rate for industrial purpose in the point of productivity, as well as in the point of manufacturing costs.

On the other hand, as an all solid state secondary battery prepared by other than the sputtering method, there have been proposed a material using a sintered body as mentioned in Patent Literature 3, Patent Literature 4, and Patent Literature 5. However, the technique of Patent Literature 3 is characterized in that a positive active material layer, a solid electrolyte layer and a negative active material layer are laminated so that they are in symmetric interposing both surfaces of a collector on a flat plate, but such a manner of lamination is not extremely practical in industrial points of view and it is clear that it is not suitable for making a multi-layered structure. Also, the technique of Patent Literature 4 is to sinter a positive electrode material containing a binder, a solid electrolyte and a negative electrode material by micro wave heating, and then, to form a positive-electrode collector and a negative-electrode collector at the outside of the sintered material, which is a single layer battery structure, and cannot be made a multi-layered structure. In Patent Literature 5, there is no disclosure of a secondary battery having a series-type structure, and further, a material having a high melting point, such as SnO₂, is used in the collector and therefore satisfactory sintering cannot be made, so that it is difficult to surely achieve electron conduction, disadvantageously causing partial charging or discharging in the battery or an increase of the internal resistance of the battery.

Patent Literature 1: JP 10-284130A

Patent Literature 2: JP 2002-42863A

Patent Literature 3: JP 2001-126756A

Patent Literature 4: JP 2001-210360A

Patent Literature 5: JP 2006-261008A

### DISCLOSURE OF THE INVENTION

### Problems to be Solved by the Invention

Accordingly, it has been still desired to develop an all solid state secondary battery which can be produced by an industrially employable method capable of mass-production and has excellent characteristics as a secondary battery.

### Means to solve the Invention

The present invention relates to an all solid state secondary battery which can be produced by an industrially employable method capable of mass-production and has excellent characteristics as a secondary battery, particularly to a wholly solid lithium ion secondary battery. More specifically, the present invention is an all solid state secondary battery comprising a laminated material, wherein the laminated material comprises a plurality of cell units and optionally a collector layer(s) constituting one of or both of an uppermost layer and a lowermost layer of the laminated material, wherein each of the cell units comprises a positive active material layer, an ion-conductive inorganic-material layer and a negative active material layer which are continuously arranged in this order, and is laminated so that the positive active material layer and the negative active material layer of adjacent cell units face each other, and wherein the laminated material is a product of co-firing. The term “co-firing” means to carry out sintering after forming a laminated block by laminating materials of the respective layers constituting the laminated materials. It preferably relates to an all solid state secondary battery in which the cell units are laminated with a metal layer interposed between them, and an all solid state secondary battery in which the co-firing is carried out at 900 to 1100° C. for 1 to 3 hours. Also, the present invention relates to an all solid state secondary battery comprising a laminated material, wherein the laminated material comprises a plurality of cell units and optionally a collector layer(s) constituting one of or both of an uppermost layer and a lowermost layer of the laminated material, wherein each of the cell units comprises a positive active material layer, an ion-conductive inorganic-material layer and a negative active material layer which are continuously arranged in this order, and is laminated so that the positive active material layer and the negative active material layer of adjacent cell units face each other, wherein each of the layers is in a sintered state. In these wholly solid secondary batteries, an interface of the adjacent layers preferably has a sintered state.

Moreover, the present invention relates to an all solid state secondary battery comprising a laminated material, wherein the laminated material comprises a plurality of cell units and optionally a collector layer(s) constituting one of or both of an uppermost layer and a lowermost layer of the laminated material, wherein each of the cell units comprises a positive active material layer, an ion-conductive inorganic-material layer and a negative active material layer which are continuously arranged in this order, and is laminated so that the positive active material layer and the negative active material layer of the adjacent cell units face each other, wherein at least the ion-conductive inorganic-material layer is formed from a calcined powder of the ion-conductive inorganic-material. In this all solid state secondary battery, the laminated material is preferably a product subjected to co-firing.

In the above-mentioned all solid state secondary battery, it is preferred that the cell units are laminated with a metal layer interposed between them; the positive active material layer comprises a lithium compound selected from the group consisting of LiCoO₂, LiNiO₂, LiMnO₂, LiMn₂O₄, LiCuO₂, LiCoVO₄, LiMnCoO₄, LiCoPO₄ and LiFePO₄, the negative active material layer comprises a lithium compound selected from the group consisting of Li_{4/3}Ti_{5/3}O₄, LiTiO₂ and LiM1ₛM2ₜOᵤ (M1 and M2 are transition metals, and s, t and u are arbitrary positive numbers), and the ion-conductive inorganic material comprises a lithium compound selected from the group consisting of Li_{3.25}Al_{0.25}SiO₄, Li₃PO₄ and LiPₓSi_{y}O_{z} (wherein x, y, z are arbitrary positive numbers); the positive active material layer comprises LiMn₂O₄, the negative active material layer comprises Li_{4/3}Ti_{5/3}O₄, and the ion-conductive inorganic-material layer comprises Li_{3.5}P_{0.5}Si_{0.5}O₄; starting materials of the positive active material, the negative active material and the ion-conductive inorganic-material each of which constitutes the positive active material layer, the negative active material layer and the ion-conductive inorganic-material layer are calcined powder; when linear shrinkage rates after heating the calcined powders which are the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%; a starting material for the positive active material is powder calcined at 700 to 800° C., a starting material for the negative active material is powder calcined at 700 to 800° C., a starting material for the ion-conductive inorganic-material is powder calcined at 900 to 1000° C., and, when linear shrinkage rates after heating the calcined powders which are the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%; the collector layer comprises a metal of any of Ag, Pd, Au and Pt, or an alloy containing any of Ag, Pd, Au and Pt, or a mixture containing two or more kinds selected from the metals and alloys; the all solid state secondary battery has extracting electrodes, respectively, at the upper end and the bottom end of the laminated material.

Moreover, the present invention relates to a process for preparing an all solid state secondary battery which comprises the following steps of (1) to (3): (1) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally, a collector paste containing powder of a collector and a metal layer paste containing metal powder for forming a metal layer; (2) repeating a cycle of coating pastes on a substrate in the order of the positive-electrode paste, the ion-conductive inorganic-material paste, the negative-electrode paste, and optionally the metal layer paste and drying them optionally; and (3) obtaining a laminated material by peeling the substrate and then, optionally coating the collector paste on one of or both of the upper end and the bottom end, and, after drying it optionally, subjecting the resultant coated material to co-firing. Further, the present invention relates to a process for preparing an all solid state secondary battery which comprises the following steps of (1′) to (4′): (1′) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally, a collector paste containing powder of a collector and a metal layer paste containing metal powder for forming a metal layer; (2′) preparing an ion-conductive inorganic-material sheet, a positive-electrode sheet and a negative-electrode sheet by coating individually an ion-conductive inorganic-material paste, a positive-electrode paste and a negative-electrode paste on respective substrates, after drying them optionally, and peeling the substrates, and optionally preparing a metal layer sheet; (3′) obtaining a laminated block by alternately laminating the sheets in the order of the positive-electrode sheet, the ion-conductive inorganic-material sheet, the negative-electrode sheet, and optionally the metal layer sheet, preferably by molding under pressure, and then optionally coating the collector paste on the upper end or bottom end, and drying the block optionally; and (4′) obtaining a laminated material by subjecting the laminated block to co-firing.

### EFFECTS OF THE INVENTION

The all solid state secondary battery of the present invention can be prepared by a method which is simple and easy, and without requiring a long time, and excellent in the point of efficiency, so that it has excellent effects that it can be employed for industrial purpose and a manufacturing cost is inexpensive. In addition, in the all solid state secondary battery of the present invention, a laminated material which comprises a plurality of cell units being laminated and optionally comprising a collector layer or collector layers constituting one of or both of an uppermost layer and a lowermost layer of the laminated material has an effect of excellent in charge-discharge characteristics of a battery. In particular, by co-firing, a laminated material which is a sintered material having good solid-solid surface connection between respective layers can be obtained and a battery having small internal resistance and good energy efficiency can be obtained.

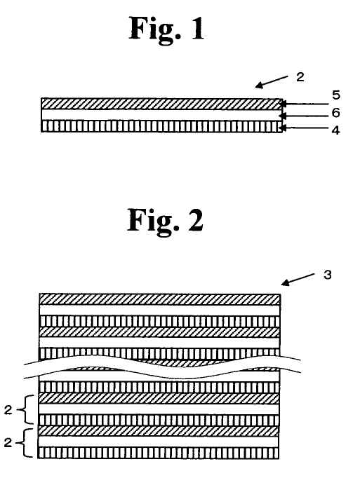

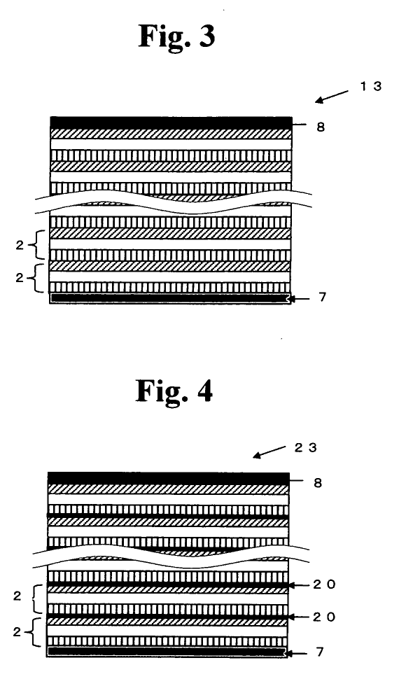

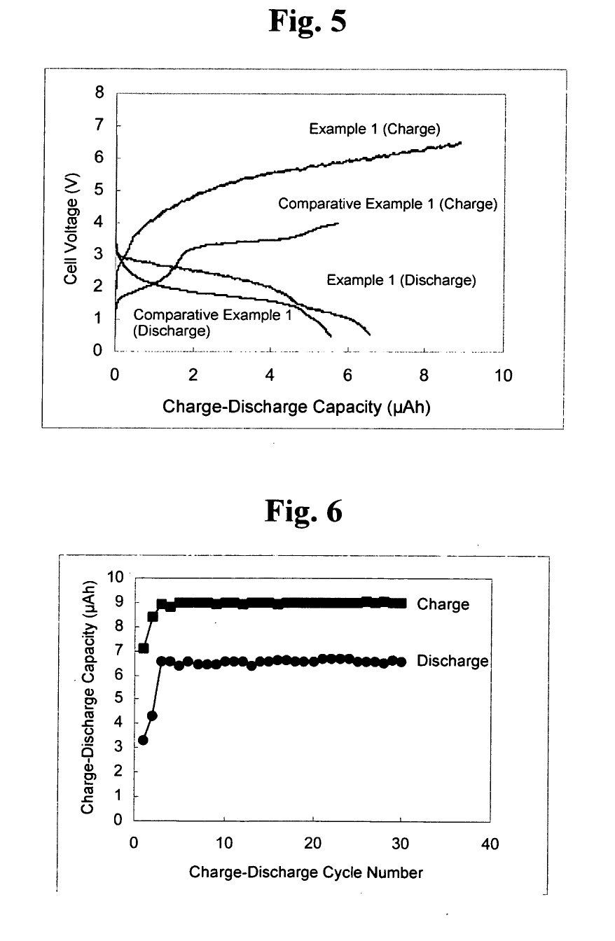

### BRIEF DESCRIPTION OF THE DRAWINGS

[FIG. 1] It is a drawing showing a cell unit which is a basic structure of the all solid state secondary battery of the present invention.

[FIG. 2] It is a drawing showing a laminated material in the all solid state secondary battery of the present invention.

[FIG. 3] It is a drawing showing a laminated material of other embodiment of the all solid state secondary battery of the present invention.

[FIG. 4] It is a drawing showing a laminated material of still other embodiment of the all solid state secondary battery of the present invention.

[FIG. 5] It is a figure showing repeated charge-discharge characteristics of the all solid state secondary battery of the present invention.

[FIG. 6] It is a figure showing a charge-discharge capacity accompanying repeated charge-discharge cycle of the all solid state secondary battery of the present invention.

### EXPLANATION OF REFERENCE NUMERALS

2 Cell unit
3 Laminated material
4 Positive active material layer
5 Negative active material layer
6 Ion-conductive inorganic-material layer
7 Collector (positive-electrode collector) layer constituting the lowermost layer
8 Collector (negative-electrode collector) layer constituting the uppermost layer
13 Laminated material
20 Metal layer
23 Laminated material

### BEST MODE TO CARRY OUT THE INVENTION

In FIG. 1, most basic structure of cell unit 2 constituting an all solid state secondary battery of the present invention is shown. Cell unit 2 has a structure comprising positive active material layer 4, ion-conductive inorganic-material layer 6, and negative active material layer 5 which are continuously arranged in this order.

In FIG. 2, the structure of a laminated material constituting the all solid state secondary battery of the present invention is shown. Laminated material 3 comprises a plurality of cell units 2 which are laminated so that positive active material layer 4 and negative active material layer 5 face each other.

In the all solid state secondary battery, it is preferred that a positive-electrode extracting electrode in contact with the positive active material layer is provided at the bottom end of the laminated material and a negative-electrode extracting electrode in contact with the negative active material layer is provided at the upper end of the laminated material. In the present specification, the terms upper end and lower end merely mean relative positional relationship.

In FIG. 3, another mode of a laminated material constituting the all solid state secondary battery of the present invention is shown. Laminated material 13 has a structure comprising a plurality of cell units 2 and collector layers constituting, respectively, the uppermost layer and the lowermost layer of the laminated material, wherein cell units 2 are laminated so that positive active material layer 4 and negative active material layer 5 face each other. One of the collector layers constituting the uppermost layer and lowermost layer is connected to the positive active material layer and serves as a positive-electrode collector, and another is connected to the negative active material layer and serves as a negative-electrode collector. In FIG. 3, collector layer 7 constituting the lowermost layer is in contact with positive active material layer 4 and serves as a positive-electrode collector, and collector layer 8 constituting the uppermost layer is in contact with negative active material layer 5 and serves as a negative-electrode collector. In the present specification, the terms of the uppermost layer and the lowermost layer merely show a relative positional relationship.

In this embodiment, the collector layer can function as an extracting electrode. In FIG. 3, collector layer 7 constituting the lowermost layer can function as a positive-electrode extracting electrode, and collector layer 8 constituting the uppermost layer can function as a negative-electrode extracting electrode. Alternatively, an extracting electrode can be separately prepared and provided on the collector layer. For example, a positive-electrode extracting electrode in contact with collector layer 7 can be provided at the bottom end of the laminated material, and a negative-electrode extracting electrode in contact with collector layer 8 can be provided at the upper end of the laminated material.

In FIG. 4, still another embodiment of a laminated material constituting the all solid state secondary battery of the present invention is shown. Laminated material 23 has a structure comprising cell units 2 laminated via a metal layer 20. By virtue of the metal layer present between the cell units, ions move only within the individual cell units, enabling the all solid state secondary battery to more surely function as a series-type all solid state secondary battery. Laminated material 23 in FIG. 4 has a collector layer, but, as mentioned above, the collector layer is optionally provided.

In the all solid state secondary battery, when the number of cell units 2 in the laminated material is two or more, a so-called series-type all solid state secondary battery can be formed. The number of the cell units may vary with a wide range based on a capacity or current value of the required all solid state secondary battery, and the merits of the present invention can be obtained in the case of three or more, and, for example, the merits are remarkable when it takes a multi-layered structure of 10 to 500 units.

The materials for the ion-conductive inorganic-material layer, the positive active material layer, the negative active material layer, and the optional collector layer and optional metal layer constituting the all solid state secondary battery of the present invention are as follows.

The ion-conductive inorganic-material layer preferably comprises a lithium compound selected from the group consisting of Li_{3.25}Al_{0.25}SiO₄, Li₃PO₄ and LiPₓSi_{y}O_{z} (wherein x, y, z are arbitrary positive numbers), but it is not limited by these. Li_{3.5}P_{0.5}Si_{0.5}O₄ is more preferred.

The positive active material layer preferably comprises a lithium compound selected from the group consisting of LiCoO₂, LiNiO₂, LiMnO₂, LiMn₂O₄, LiCuO₂, LiCoVO₄, LiMnCoO₄, LiCoPO₄ and LiFePO₄, but it is not limited by these. LiCoO₂, LiMnO₂ or LiMn₂O₄ is more preferred.

The negative active material layer preferably comprises a lithium compound selected from the group consisting of Li_{4/3}Ti_{5/3}O₄, LiTiO₂ and LiM1ₛM2ₜOu (M1 and M2 are transition metals, and s, t and u are arbitrary positive numbers), but it is not limited by these. Li_{4/3}Ti_{5/3}O₄ or LiTiO₂ is more preferred.

Either of the optional collector layer which functions as a positive-electrode collector and the optional collector layer which functions as a negative-electrode collector can be any of a metal of Ag, Pd, Au and Pt, or may comprise an alloy containing any of Ag, Pd, Au and Pt. In the case of the alloy, an alloy comprising two or more kinds selected from Ag, Pd, Au and Pt is preferred, and for example, an Ag/Pd alloy. These metals and alloys may be used alone, or in a mixture of two or more kinds. The material for the collector layer functioning as a positive-electrode collector and the material for the collector layer functioning as a negative-electrode collector may be the same or different. In particular, in an alloy or a mixed powder comprising Ag and Pd, a melting point can be continuously and optionally changed from a melting point of silver (962° C.) to a melting point of palladium (1550° C.) according to a mixing ratio, so that a melting point can be adjusted depending on a co-firing temperature. Moreover, electron conductivity is high so that there is an advantage that an internal resistance of a battery can be controlled to a minimum value.

In the optional metal layer, the same material as the above-mentioned material for the collector layer can be used. The material for the metal layer and the material for the collector layer may be the same or different.

In the all solid state secondary battery of the present invention, the laminated material can be prepared by using pasted materials of the ion-conductive inorganic material, the positive active material, the negative active material, and the respective materials for forming the optional collector layer and optional metal layer.

Here, starting materials of the positive active material layer, the negative active material layer and the ion-conductive inorganic-material layer to be used for making pastes, powders in which inorganic salts, etc., which are starting materials thereof have been calcined can be used. In the point of developing respective functions sufficiently after co-firing by proceeding chemical reactions of the starting materials according to calcination, calcination temperatures with regard to the positive active material, the negative active material and the ion-conductive inorganic-material are each preferably 700° C. or higher.

Further, when each layer is formed by using a calcined positive active material, negative active material and ion-conductive inorganic-material, each substance is tend to be shrunk after the co-firing. In order to obtain good battery characteristics by controlling degrees of shrinkages of the positive active material, the negative active material and the ion-conductive inorganic-material after the co-firing, and controlling occurrence of bending or peeling due to crack or strain, it is preferred that the ion-conductive inorganic-material is calcined at a higher temperature than that of the positive active material and negative active material. More specifically, a positive active material calcined at 700 to 800° C., a negative active material calcined at 700 to 800° C., and an ion-conductive inorganic-material calcined at 900 to 1000° C., preferably at 950 to 1000° C. can be used in combination.

Moreover, with regard to the positive active material, the negative active material and the ion-conductive inorganic-material, when linear shrinkage rates thereof at the time of heating to the temperature of the co-firing are made a %, b % and c %, respectively, it is preferred that the calcined positive active material, negative active material and ion-conductive inorganic-material are used so that a difference between the maximum value and the minimum value is within 6% by controlling the calcination temperatures. According to this, good battery characteristics can be obtained by controlling occurrence of bending or peeling due to crack or strain.

Here, the linear shrinkage rate is a value measured by the following.
(1) Powder which is an object to be measured is pressed with 0.5 t/cm² [49 NPa] to prepare a test piece with a thickness of 0.8 to 1.2 mm, and cut to prepare a test piece having a length of 1.5 mm, a width of 1.5 mm, and a thickness of 0.8 to 1.2 mm.
(2) By using a thermal analyzer (manufactured by MacScience Co., Ltd.), change in thickness after heating to a predetermined temperature is measured while applying a load of 0.44 g/mm² to the test piece according to the thermomechanical analysis method.
(3) A value in which the measured value is substituted to the following equation is made a linear shrinkage rate.

$$Linear shrinkage rate [ \% ] = \frac{\begin{matrix}Initial thickness - \\ \begin{matrix}Thickness after heating to \\ predetermined temperature\end{matrix}\end{matrix}}{Initial thickness} \times 100$$

For example, positive active materials calcined at 700 to 800° C. such as LiCoO₂, LiNiO₂, LiMnO₂, LiMn₂O₄, LiCuO₂, LiCoVO₄, LiMnCoO₄, LiCoPO₄, LiFePO₄, etc., negative active materials calcined at 700 to 800° C. such as Li_{4/3}Ti_{5/3}O₄, LiTiO₂, LiM1ₛM2ₜOᵤ (M1 and M2 are transition metals, and s, t and u are arbitrary positive numbers), etc., can be used in combination with ion-conductive inorganic-materials calcined at 900 to 1000° C. such as Li_{3.25}Al_{0.25}SiO₄, Li₃PO₄, LiPₓSi_{y}O_{z} (wherein x, y and z are arbitrary positive numbers), etc., such that a difference of the maximum value and the minimum value of the linear shrinkage rates a %, b % and c % becomes within 6%.

A method of making a paste of each material is not particularly limited, and, for example, powder of the above-mentioned respective materials is mixed with a vehicle comprising an organic solvent and a binder to obtain a paste. For example, a collector paste can be prepared by mixing a vehicle with a mixture of metal powders of Ag and Pd, synthetic powder of Ag/Pd by a co-precipitation method or powder of an Ag/Pd alloy.

The pastes of the respective materials are coated on a substrate with a desired order, after drying them optionally, the substrate is peeled off optionally, to obtain a laminated block, and the laminated block is subjected to co-firing whereby a laminated material can be obtained. Also, with respective parts (e.g., cell units) of a laminated material, each paste is coated in the order corresponding to the part on a substrate, and after drying them optionally, a material in which the substrate is peeled off is prepared, and they are laminated and molded under pressure, and subjected to co-firing to prepare a material. Incidentally, a method of coating the paste is not particularly limited, and conventionally known methods such as screen printing, transfer printing, doctor-blade, etc., can be employed.

More specifically, there may be mentioned a process for preparing an all solid state secondary battery which comprises the following steps of (1) to (3):
(1) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally, a collector paste containing powder of a collector and a metal layer paste containing metal powder for forming a metal layer;
(2) repeating a cycle of coating pastes on a substrate in the order of the positive-electrode paste, the ion-conductive inorganic-material paste, the negative-electrode paste, and optionally the metal layer paste and drying them optionally; and
(3) obtaining a laminated material by peeling the substrate and then, optionally coating the collector paste on one of or both of the upper end and the bottom end, and, after drying it optionally, subjecting the resultant coated material to co-firing.

Also, there may be mentioned a process for preparing an all solid state secondary battery which comprises the following steps of (1′) to (4′):
(1′) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally a collector paste containing powder of a collector and a metal layer paste containing metal powder for forming a metal layer;
(2′) preparing an ion-conductive inorganic-material sheet, a positive-electrode sheet and a negative-electrode sheet by coating individually an ion-conductive inorganic-material paste, a positive-electrode paste, and a negative-electrode paste on respective substrates, after drying them optionally, and peeling the substrates, and optionally preparing a metal layer sheet;
(3′) obtaining a laminated block by alternately laminating the sheets in the order of the positive-electrode sheet, the ion-conductive inorganic-material sheet, the negative-electrode sheet, and optionally the metal layer sheet, preferably by molding under pressure, and then optionally coating the collector paste on the upper end or bottom end, and drying the block optionally; and
(4′) obtaining a laminated material by subjecting the laminated block to co-firing. In this process, when forming a metal layer, instead of the metal layer sheet prepared in an independent form, there can be used a material obtained by, for example, coating the metal layer paste containing metal powder on the positive-electrode paste layer of the positive-electrode sheet or the negative-electrode paste layer of the negative-electrode sheet and drying it optionally.

The co-firing can be carried out in the air, and, for example, a sintering temperature can be made at 900 to 1100° C. for 1 to 3 hours. By sintering such a temperature, each layer is in a sintered state, and an interface of the adjacent layers can be made in a sintered state. This means that the portion between particles of each layer formed by calcined powder particles is in a sintered state, and the portion between particles of the layers adjacent to each other is also in a sintered state.

Also, the extracting electrode(s) can be provided at one of or both of the upper end and the bottom end of the laminated material, for example, by coating an extracting electrode paste containing conductive powder (for example, Ag powder), glass frit, vehicle, etc., on the upper end and bottom end of the laminated material, and then, sintering it at a temperature of 600 to 900° C.

### Examples

In the following, the present invention is explained in detail by referring to Examples, but the present invention is not limited by these Examples. Indication of part(s) means part(s) by weight otherwise specifically mentioned.

### Example 1

### (Preparation of Positive-Electrode Sheet)

As the positive active material, LiMn₂O₄ prepared by the following method was used.

Li₂CO₃ and MnCO₃ were used as starting materials, and they were weighed with a molar ratio of 1:4, subjected to wet mixing by a ball mill using water as a dispersing medium for 16 hours, and then, dehydrated and dried. The obtained powder was calcined in air at 800° C. for 2 hours. The calcined product was roughly pulverized, subjected to wet mixing by a ball mill using water as a dispersing medium for 16 hours, and then, dehydrated and dried to obtain calcined powder of a positive active material. An average particle diameter of the calcined powder was 0.30 μm. Also, the composition is to be LiMn₂O₄ was confirmed by using an X-ray diffraction device.

Then, to 100 parts of the calcined powder were added 100 parts of ethanol and 200 parts of toluene in a ball mill to carry out wet mixing, thereafter 16 parts of a polyvinyl butyral series binder and 4.8 parts of benzyl butyl phthalate were further added to the mixture and the mixture was mixed to prepare a positive-electrode paste. This positive-electrode paste was subjected to sheet molding using a PET film as a substrate by the doctor-blade method, and then the PET film was peeled off to obtain a positive-electrode sheet with a thickness of 13 μm.

### (Preparation of Negative-Electrode Sheet)

As the negative active material, Li_{4/3}Ti_{5/3}O₄ prepared by the following method was used.

Li₂CO₃ and MnCO₃ were used as starting materials, and they were weighed with a molar ratio of 2:5, subjected to wet mixing by a ball mill using water as a dispersing medium for 16 hours, and then, dehydrated and dried. The obtained powder was calcined in air at 800° C. for 2 hours. The calcined product was roughly pulverized, subjected to wet mixing by a ball mill using water as a dispersing medium for 16 hours, and then, dehydrated and dried to obtain calcined powder of a negative active material. An average particle diameter of the calcined powder was 0.32 μm. Also, the composition is to be Li_{4/3}Ti_{5/3}O₄ was confirmed by using an X-ray diffraction device.

Then, to 100 parts of the calcined powder were added 100 parts of ethanol and 200 parts of toluene in a ball mill to carry out wet mixing, thereafter 16 parts of a polyvinyl butyral series binder and 4.8 parts of benzyl butyl phthalate were further added to the mixture and the mixture was mixed to prepare a negative-electrode paste. This negative-electrode paste was subjected to sheet molding using a PET film as a substrate by the doctor-blade method, and then the PET film was peeled off to obtain a negative-electrode sheet with a thickness of 13 μm.

### (Preparation of Ion-Conductive Inorganic-Material Sheet)

As the ion-conductive inorganic-material, Li_{3.5}Si_{0.5}P_{0.5}O₄ prepared by the following method was used.

Li₂CO₃, SiO₂ and commercially available Li₃PO₄ were used as starting materials, and they were weighed with a molar ratio of 2:1:1, subjected to wet mixing by a ball mill using water as a dispersing medium for 16 hours, and then, dehydrated and dried. The obtained powder was calcined in air at 950° C. for 2 hours. The calcined product was roughly pulverized, subjected to wet mixing by a ball mill using water as a dispersing medium for 16 hours, and then, dehydrated and dried to obtain calcined powder of an ion-conductive inorganic-material. An average particle diameter of the calcined powder was 0.54 μm. Also, the composition is to be Li_{3.5}Si_{0.5}P_{0.5}O₄ was confirmed by using an X-ray diffraction device.

To 100 parts of the calcined powder of the ion-conductive inorganic-material were added 100 parts of ethanol and 200 parts of toluene in a ball mill to carry out wet mixing, thereafter 16 parts of a polyvinyl butyral series binder and 4.8 parts of benzyl butyl phthalate were further added to the mixture and the mixture was mixed to prepare an ion-conductive inorganic-material paste. This ion-conductive inorganic-material paste was subjected to sheet molding using a PET film as a substrate by the doctor-blade method, and then the PET film was peeled off to obtain an ion-conductive inorganic-material sheet with a thickness of 13 μm.

### (Preparation of Extracting Electrode Paste)

100 parts of Ag powder and 5 parts of glass frit were mixed, and 10 parts of ethyl cellulose as a binder and 60 parts of dihydroterpineol as a solvent were added to the mixture, and the mixture was kneaded and dispersed by a triple roll mill to prepare an extracting electrode paste.

By using these sheets and paste, an all solid state secondary battery was prepared by the following manner.

### (Preparation of Laminated Material)

The negative-electrode sheet, ion-conductive inorganic material, and positive-electrode sheet were laminated in this order so that two cell units were formed. Thereafter, the laminated material was molded at a temperature of 80° C. and a pressure of 1000 kgf/cm² [98 MPa], then, cut to prepare a laminated block. Thereafter, the laminated block was subjected to firing to obtain a laminated material. The co-firing was carried out by elevating a temperature in air with a temperature elevation rate of 200° C./hr to 1000° C., maintained at the temperature for 2 hours, and after sintering, it was naturally cooled. The thus obtained laminated material after sintering had a thickness of each ion-conductive inorganic-material of 7 μm, a thickness of each positive active material of 7 μm, and a thickness of each negative active material of 7 μm.

### (Formation of Extracting Electrode)

An extracting electrode paste was coated at the upper end and bottom end of the laminated material, and sintered at 750° C. to obtain an all solid state secondary battery in Example 1.

As Comparative Example 1, an all solid state secondary battery in Comparative Example 1 was prepared in substantially the same manner as in the above-mentioned method except that one cell unit was formed.

### (Evaluation)

A test was made to confirm that the all solid state secondary battery in Example 1 properly operated as a battery, and lead wires were attached to the respective extracting electrodes, and repeated charge-discharge test was carried out. The measurement conditions were set that a current at the time of charging and discharging was each 2 μA, a truncation voltage at the time of charging and discharging were each 8V and 0.5V, and a charge-discharge time was within 300 minutes. With respect to the battery in Comparative Example 1, a measurement was conducted under the same conditions. The results are shown in FIG. 5.

As shown in FIG. 6, the all solid state secondary battery of the present invention showed excellent repeated charge-discharge characteristics and it can be understood that they have excellent functions as a secondary battery. Also, as shown in FIG. 6, with regard to the charge-discharge capacity, fluctuation could be found at the 3rd cycle, and thereafter it became stable to show a substantially constant curve. A discharge initiation voltage at the 3rd cycle at which charge-discharge became stable was 3.8V, and a charge capacity and a discharge capacity were 9 μAh and 6.5 μAh, respectively.

### Comparative Example 2

By using the same positive-electrode paste, negative-electrode paste, and ion-conductive inorganic-material paste as in Example 1, one paste was coated on an alumina substrate and sintered, then a next paste was coated and sintered and this procedure was repeated to try to prepare a wholly solid battery so as to have the same series structure as in Example 1. The sintering temperatures were the same temperatures as in Example 1.

However, the ion-conductive inorganic-material paste was coated on the alumina substrate and sintered, and on the obtained ion-conductive inorganic-material layer was coated the positive-electrode paste and sintered, then the ion-conductive inorganic-material layer and the positive active material layer were markedly peeled off Thus, the next step could not be carried out and an all solid state secondary battery having the same series structure as in Example 1 could not be prepared by this method. This is because, in the second sintering, the ion-conductive inorganic-material layer which had been once subjected to sintering did not shrink any more, whereas the positive active material layer which was to carry out a first sintering shrunk whereby behaviors were different between the layers so that crack or peeling would be considered to be caused. Also, when the method as in Comparative example 2 is employed, it is necessary to sinter in each step so that production efficiency is extremely bad.

### Example 2

In the same manner as in Example 1 except for changing the calcination temperature to a temperature as shown in Table 1, the positive active material, the negative active material and the calcined powder of an ion-conductive inorganic-material were obtained. With regard to each calcined powder, a linear shrinkage rate was measured as follows. The results are shown in Table 1.
(1) Calcined powder which is an object to be measured was pressed with 0.5 t/cm² [49 MPa] to prepare a test piece with a thickness of 0.8 to 1.2 mm, and cut to prepare a test piece having a length of 1.5 mm, a width of 1.5 mm and a thickness of 0.8 to 1.2 mm.
(2) By using a thermal analyzer (manufactured by MacScience Co., Ltd.), change in thickness after heating to 1000° C. was measured while applying a load of 0.44 g/mm² to the test piece according to the thermomechanical analysis method.
(3) The measured value was substituted to the following equation to obtain a linear shrinkage rate.

$$Linear shrinkage rate [ \% ] = \frac{\begin{matrix}\begin{matrix}Initial thickness - \\ Thickness after\end{matrix} \\ heating to 1000 ° C . \end{matrix}}{Initial thickness} \times 100$$

TABLE 1

| | Positive-electrode | Negative-electrode | Ion-conductive |
|---|---|---|---|
| Calcination | active-substance | active-substance | inorganic-material |
| temperature | Linear shrinkage | Linear shrinkage | Linear shrinkage |
| [° C.] | rate a [%] | rate b [%] | rate c [%] |
| 700 | 10.0 | 10.0 | 18.0 |
| 800 | 8.0 | 8.0 | 16.5 |
| 900 | 5.5 | 5.5 | 16.0 |
| 950 | 5.0 | 4.5 | 14.0 |
| 1000 | 4.0 | 2.5 | 12.0 |

Calcined powders of the positive active material, the negative active material and the ion-conductive inorganic-material with various calcination temperatures were combined to prepare batteries in the same manner as in Example 1, and occurrence of crack or peeling were observed. The results are shown in Table 2.

TABLE 2

| | | | | | | | Difference in | |
|---|---|---|---|---|---|---|---|---|
| | | | | | | | Linear | |
| | Positive- | | Negative- | | | | shrinkage | |
| | electrode | | electrode | | Ion-conductive | | rate | |
| | active- | | active- | | inorganic- | | (Maximum | Presence |
| | substance | | substance | | material | | value − | or |
| | Calcination | Linear | Calcination | Linear | Calcination | Linear | minimum | absence of |
| | temperature | shrinkage rate | temperature | shrinkage rate | temperature | shrinkage rate | value) | crack or |
| Example | (° C.) | (%) | (° C.) | (%) | (° C.) | (%) | (%) | peeling |
| 2-1 | 800 | | 800 | | 950 | | 6.0 | None |
| | | 8.0 | | 8.0 | | 14.0 | | |
| 2-2 | 700 | | 700 | | 950 | | 4.0 | None |
| | | 10.0 | | 10.0 | | 14.0 | | |
| 2-3 | 700 | | 800 | | 950 | | 6.0 | None |
| | | 10.0 | | 8.0 | | 14.0 | | |
| 2-4 | 800 | | 700 | | 950 | | 6.0 | None |
| | | 8.0 | | 10.0 | | 14.0 | | |
| 2-5 | 800 | | 800 | | 900 | | 8.0 | Present |
| | | 8.0 | | 8.0 | | 16.0 | | |
| 2-6 | 800 | | 800 | | 1000 | | 4.0 | None |
| | | 8.0 | | 8.0 | | 12.0 | | |
| 2-7 | 700 | | 700 | | 900 | | 6.0 | None |
| | | 10.0 | | 10.0 | | 16.0 | | |
| 2-8 | 700 | | 700 | | 1000 | | 2.0 | None |
| | | 10.0 | | 10.0 | | 12.0 | | |
| 2-9 | 900 | | 900 | | 900 | | 10.5 | Present |
| | | 5.5 | | 5.5 | | 16.0 | | |
| 2-10 | 900 | | 900 | | 1000 | | 6.5 | Present |
| | | 5.5 | | 5.5 | | 12.0 | | |

It could be confirmed that an all solid state secondary battery which uses a combination of a positive active material and a negative active material with a calcination temperature of 700 to 800° C., and an ion-conductive inorganic-material with a calcination temperature of 900 to 1000° C., and when linear shrinkage rates a, b and c with a difference between the maximum value and the minimum value within 6%, shows no occurrence of crack and peeling, and it works extremely good as a battery.

### INDUSTRIAL UTILIZABILITY

The present invention is as mentioned above, an all solid state secondary battery with a structure in which series connection can be done simply and easily, and by more laminating a number of lamination, voltage can be made larger, so that it is an invention which can be utilized in industry with a great extent.

1. An all solid state secondary battery comprising a laminated material,
wherein the laminated material comprises a plurality of cell units and optionally a collector layer(s) constituting one of or both of an uppermost layer and a lowermost layer of the laminated material,
wherein each of the cell units comprises a positive active material layer, an ion-conductive inorganic-material layer and a negative active material layer which are continuously arranged in this order, and is laminated so that the positive active material layer and the negative active material layer of adjacent cell units face each other, and
wherein the laminated material is a product of co-firing.

2. The all solid state secondary battery according to claim 1, wherein the co-firing is carried out at 900 to 1100° C. for 1 to 3 hours.

3. An all solid state secondary battery comprising a laminated material,
wherein the laminated material comprises a plurality of cell units and optionally a collector layer(s) constituting one of or both of an uppermost layer and a lowermost layer of the laminated material,
wherein each of the cell units comprises a positive active material layer, an ion-conductive inorganic-material layer and a negative active material layer which are continuously arranged in this order, and is laminated so that the positive active material layer and the negative active material layer of adjacent cell units face each other,
wherein each of the layers is in a sintered state.

4. The all solid state secondary battery according to claim 1, wherein each of adjacent layers has an interface in a sintered state.

5. An all solid state secondary battery comprising a laminated material
wherein the laminated material comprises a plurality of cell units and optionally a collector layer(s) constituting one of or both of an uppermost layer and a lowermost layer of the laminated material,
wherein each of the cell units comprises a positive active material layer, an ion-conductive inorganic-material layer and a negative active material layer which are continuously arranged in this order, and is laminated so that the positive active material layer and the negative active material layer of the adjacent cell units face each other,
wherein at least the ion-conductive inorganic-material layer is formed from a calcined powder of the ion-conductive inorganic-material.

6. The all solid state secondary battery according to claim 5, wherein the laminated material is a product subjected to co-firing.

7. The all solid state secondary battery according to claim 1, wherein the cell units are laminated with a metal layer interposed between them.

8. The all solid state secondary battery according to claim 1,
wherein the positive active material layer comprises a lithium compound selected from the group consisting of LiCoO₂, LiNiO₂, LiMnO₂, LiMn₂O₄, LiCuO₂, LiCoVO₄, LiMnCoO₄, LiCoPO₄ and LiFePO₄.
the negative active material layer comprises a lithium compound selected from the group consisting of Li_{4/3}Ti_{5/3}O₄, LiTiO₂ and LiM1ₛM2ₜOᵤ (M1 and M2 are transition metals, and s, t and u are arbitrary positive numbers), and
the ion-conductive inorganic material comprises a lithium compound selected from the group consisting of Li_{3.25}Al_{0.25}SiO₄, Li₃PO₄ and LiPₓSi_{y}O_{z} (wherein x, y, z are arbitrary positive numbers).

9. The all solid state secondary battery according to claim 1,
wherein the positive active material layer comprises LiMn₂O₄,
the negative active material layer comprises Li_{4/3}Ti_{5/3}O₄, and
the ion-conductive inorganic-material layer comprises Li_{3.5}P_{0.5}Si_{0.5}O₄.

10. The all solid state secondary battery according to claim 1,
wherein starting materials of the positive active material, the negative active material,and the ion-conductive inorganic-material each of which constitutes the positive active material layer, the negative active material layer and the ion-conductive inorganic-material layer, respectively, are calcined powders.

11. The all solid state secondary battery according to claim 10,
wherein when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.

12. The all solid state secondary battery according to claim 10,
wherein the starting material for the positive active material is powder calcined at 700 to 800° C.,
the starting material for the negative active material is powder calcined at 700 to 800° C.,
the starting material for the ion-conductive inorganic-material is powder calcined at 900 to 1000° C.,
and, when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.

13. The all solid state secondary battery according to claim 1, wherein the collector layer comprises a metal of any of Ag, Pd, Au and Pt, or an alloy containing any of Ag, Pd, Au and Pt, or a mixture containing two or more kinds selected from the metals and alloys.

14. The all solid state secondary battery according to claim 1, which has extracting electrodes at an upper end and a bottom end of the laminated material.

15. A process for preparing an all solid state secondary battery which comprises the following steps of (1) to (3):
(1) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally, a collector paste containing powder of a collector and a metal layer paste containing metal powder for forming a metal layer;
(2) repeating a cycle of coating pastes on a substrate in the order of the positive-electrode paste, the ion-conductive inorganic-material paste, the negative-electrode paste, and optionally the metal layer paste and drying them optionally; and
(3) obtaining a laminated material by peeling the substrate and then, optionally coating the collector paste on one of or both of the upper end and the bottom end, and, after drying it optionally, subjecting the resultant coated material to co-firing.

16. A process for preparing an all solid state secondary battery which comprises the following steps of (1′) to (4′):
(1′) preparing a positive-electrode paste containing calcined powder of a positive active material, a negative-electrode paste containing calcined powder of a negative active material, an ion-conductive inorganic-material paste containing calcined powder of an ion-conductive inorganic-material, and optionally, a collector paste containing powder of a collector and a metal layer paste containing metal powder for forming a metal layer;
(2′) preparing an ion-conductive inorganic-material sheet, a positive-electrode sheet and a negative-electrode sheet by . coating individually an ion-conductive inorganic-material paste, a positive-electrode paste and a negative-electrode paste on respective substrates, after drying them optionally, and peeling the substrates, and optionally preparing a metal layer sheet;
(3′) obtaining a laminated block by alternately laminating the sheets in the order of the positive-electrode sheet, the ion-conductive inorganic-material sheet, the negative-electrode sheet, and optionally the metal layer sheet, preferably by molding under pressure, and then optionally coating the collector paste on the upper end or bottom end, and drying the block optionally; and
(4′) obtaining a laminated material by subjecting the laminated block to co-firing.

17. The all solid state secondary battery according to claim 3,
wherein the positive active material layer comprises a lithium compound selected from the group consisting of LiCoO₂, LiNiO₂, LiMnO₂, LiMn₂O₄, LiCuO₂, LiCoVO₄, LiMnCoO₄, LiCoPO₄ and LiFePO₄,
the negative active material layer comprises a lithium compound selected from the group consisting of Li_{4/3}Ti_{5/3}O₄, LiTiO₂ and LiM1ₛM2ₜOᵤ (M1 and M2 are transition metals, and s, t and u are arbitrary positive numbers), and
the ion-conductive inorganic material comprises a lithium compound selected from the group consisting of Li_{3.25}Al_{0.25}SiO₄, Li₃PO₄ and LiPₓSi_{y}O_{z} (wherein x, y, z are arbitrary positive numbers).

18. The all solid state secondary battery according to claim 3,
wherein the positive active material layer comprises LiMn₂O₄,
the negative active material layer comprises Li_{4/3}Ti_{5/3}O₄, and
the ion-conductive inorganic-material layer comprises Li_{3.5}P_{0.5}Si_{0.5}O₄.

19. The all solid state secondary battery according to claim 3,
wherein starting materials of the positive active material, the negative active material and the ion-conductive inorganic-material each of which constitutes the positive active material layer, the negative active material layer and the ion-conductive inorganic-material layer, respectively, are calcined powders, and
wherein when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.

20. The all solid state secondary battery according to claim 3,
wherein starting materials of the positive active material, the negative active material and the ion-conductive inorganic-material each of which constitutes the positive active material layer, the negative active material layer and the ion-conductive inorganic-material layer, respectively, are calcined powders, and
wherein the starting material for the positive active material is powder calcined at 700 to 800° C.,
the starting material for the negative active material is powder calcined at 700 to 800° C.,
the starting material for the ion-conductive inorganic-material is powder calcined at 900 to 1000° C.,
and, when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.

21. The all solid state secondary battery according to claim 5,
wherein the positive active material layer comprises a lithium compound selected from the group consisting of LiCoO₂, LiNiO₂, LiMnO₂, LiMn₂O₄, LiCuO₂, LiCoVO₄, LiMnCoO₄, LiCoPO₄ and LiFePO₄,
the negative active material layer comprises a lithium compound selected from the group consisting of Li_{4/3}Ti_{5/3}O₄, LiTiO₂ and LiM1ₛM2ₜOᵤ (M1 and M2 are transition metals, and s, t and u are arbitrary positive numbers), and
the ion-conductive inorganic material comprises a lithium compound selected from the group consisting of Li_{3.25}Al_{0.25}SiO₄, Li₃PO₄ and LiPₓSi_{y}O_{z} (wherein x, y, z are arbitrary positive numbers).

22. The all solid state secondary battery according to claim 5,
wherein the positive active material layer comprises LiMn₂O₄,
the negative active material layer comprises Li_{4/3}Ti_{5/3}O₄, and
the ion-conductive inorganic-material layer comprises Li_{3.5}P_{0.5}Si_{0.5}O₄.

23. The all solid state secondary battery according to claim 5,
wherein starting materials of the positive active material, the negative active material and the ion-conductive inorganic-material each of which constitutes the positive active material layer, the negative active material layer and the ion-conductive inorganic-material layer, respectively, are calcined powders, and
wherein when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.

24. The all solid state secondary battery according to claim 5,
wherein starting materials of the positive active material, the negative active material and the ion-conductive inorganic-material each of which constitutes the positive active material layer, the negative active material layer and the ion-conductive inorganic-material layer, respectively, are calcined powders, and
wherein the starting material for the positive active material is powder calcined at 700 to 800° C.,
the starting material for the negative active material is powder calcined at 700 to 800° C.,
the starting material for the ion-conductive inorganic-material is powder calcined at 900 to 1000° C.,
and, when linear shrinkage rates after heating the calcined powder which is the starting material of the positive active material, the calcined powder which is the starting material of the negative active material and the calcined powder which is the starting material of the ion-conductive inorganic-material at a temperature of the co-firing are made a %, b % and c %, respectively, the difference between the maximum value and the minimum value thereof is within 6%.
